(19) United States
(12) Patent Application Publication
(10) Pub. No.: US 2007/0070387 A1
(43) Pub. Date: Mar. 29, 2007

(54) IMAGE FORMING APPARATUS, ADDITIONAL APPARATUS CONNECTABLE TO IMAGE FORMING APPARATUS, IMAGE FORMING SYSTEM, AND CONTROL METHOD THEREOF

(76) Inventor: Sun-jin KIM, Suwon-si (KR)

Correspondence Address: STANZIONE & KIM, LLP, 919 18TH STREET, N.W., SUITE 440, WASHINGTON, DC, 20006, US

(21) Appl. No.: 11/535,250

(22) Filed: Sep. 26, 2006

(30) Foreign Application Priority Data
Sep. 27, 2005 (KR) 2005-89643

(51) Int. Cl. G06K 15/00

(52) U.S. Cl. 358/1.14; 358/1.13

(57) ABSTRACT

An image forming apparatus, an additional apparatus and a control method thereof, operated in a normal mode or a power-saving mode, includes a signal receiving part, an interface part of the image forming apparatus, to which a predetermined additional apparatus is installed, an installation detecting part to detect whether the additional apparatus is installed at the interface part of the image forming apparatus, and a control part of the image forming apparatus to output a power-saving signal to the additional apparatus installed at the interface part of the image forming apparatus when the image forming apparatus is operated in the power-saving mode, and to output a normal signal when a predetermined input signal is input

### CROSS-REFERENCE TO RELATED APPLICATIONS

This application claims priority from Korean Patent Application No. 2005-0089643, filed on Sep. 27, 2005, in the Korean Intellectual Property Office, the disclosure of which is incorporated herein by reference.

### BACKGROUND OF THE INVENTION

1. Field of the Invention

The present general inventive concept relates to an image forming apparatus, an additional apparatus connectable to the image forming apparatus, and a control method thereof, and more particularly, to an image forming apparatus, an additional apparatus connectable to the image forming apparatus, and a control method thereof, in which a power supplying unit provided in the image forming apparatus supplies power to the additional apparatus.

2. Description of the Related Art

Generally, an apparatus for forming an image, such as a copier, a printer, a multi-function peripheral (MFP), a facsimile, etc., is commonly referred to as an image forming apparatus. The MFP is a multi-functional terminal in which individual terminals, such as a facsimile, a scanner, a printer, a copier and the like, are integrated into a single apparatus. The MFP may be used independently or together with a computer.

As an operational speed of the image forming apparatus has increased and the image forming apparatus has become multi-functional, various functions for printing paper have been added to the image forming apparatus. Thus, the image forming apparatus may selectively use an additional apparatus, such as a separate paper discharger, e.g., a finisher which specially performs various paper discharging functions, a high capacity paper feeder which can enlarge a paper feeding function and load a large quantity of printing papers, an auto duplex feeder which performs a double-sided copying function, etc.

However, once the additional apparatus is installed at a conventional image forming apparatus, although the additional apparatus is not used, power is supplied to the additional apparatus. Therefore, in the conventional image forming apparatus, there is a problem that power consumption is increased according to installation of the additional apparatus.

### SUMMARY OF THE INVENTION

The present general inventive concept provides an image forming apparatus, an additional apparatus connectable to the image forming apparatus, and a control method thereof, in which power can be supplied only to the additional apparatus if necessary.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an image forming apparatus having a normal mode and a power-saving mode, the image forming apparatus comprising a signal receiving part, an interface part to which a predetermined additional apparatus is installed, an installation detecting part to detect whether the additional apparatus is installed at the interface part of the image forming apparatus, and a control part to output a power-saving signal including power-saving mode information of operating in the power-saving mode to the additional apparatus installed at the interface part of the image forming apparatus through the interface part of the image forming apparatus when the image forming apparatus is operated in the power-saving mode, and to output a normal signal including normal mode information of operating the additional apparatus in the normal mode through the interface part of the image forming apparatus when a predetermined input signal is input through the signal receiving part.

The control part of the image forming apparatus may be operated in the normal mode when the input signal is received.

The additional apparatus may include a plurality of additional apparatuses installed at the interface part of the image forming apparatus, and the control part outputs the normal signal only to the additional apparatuses corresponding to the input signal when the input signal is received.

The installation detecting part may comprise at least one of a pull-up resistor and a pull-down resistor, and outputs at least one of a pull-up signal and a pull-down signal as a detecting signal generated by the at least one pull-up resistor and the pull-down resistor to the control part.

The apparatus may further comprise a power supplying part to supply power to the additional apparatus corresponding to the input signal.

The power-saving signal may break the power from the power supplying part to the additional apparatus, and the normal signal supplies the power to the additional apparatus.

The apparatus may further comprise a feedback circuit to feed back a power status of the additional apparatus, wherein the control part of the image forming apparatus determines the power status of the additional apparatus by the feedback circuit.

The apparatus may further comprise a display part to display an image, and the control part of the image forming apparatus determines whether the power is supplied to the additional apparatus and controls the display part to display the power status of the additional apparatus according to a determination of whether the additional apparatus is in the normal mode or the power saving mode.

The foregoing and/or other aspects and utilities of the present general inventive concept may also be achieved by providing an additional apparatus usable with an image forming apparatus having an interface part, a power supplying part to output power through an interface part of the image forming apparatus, and a control part to output a power-saving signal including power-saving mode information through the interface part when the image forming apparatus is operated in the power-saving mode, the additional apparatus comprising a power switching part to switch power supplied from an image forming apparatus, and a control part to control the power switching part to break the power when a power-saving signal is received from the image forming apparatus.

The control part may control the power switching part to supply the power when a normal signal including normal mode information of operating in a normal mode is received from the image forming apparatus.

The foregoing and/or other aspects and utilities of the present general inventive concept may also be achieved by providing a method of controlling an image forming apparatus, which is operated in a normal mode or a power-saving mode, the method comprising installing a predetermined additional apparatus on an image forming apparatus, detecting whether the additional apparatus is installed, outputting a power-saving signal including power-saving mode information of operating in a power-saving mode to the additional apparatus when the image forming apparatus is operated in the power-saving mode, receiving a predetermined input signal, and outputting a normal signal including normal mode information of operating the additional apparatus in a normal mode when the input signal is received.

The method may further comprise operating the image forming apparatus in the normal mode when the predetermined input signal is received.

The installing of the predetermined additional apparatus may comprise installing a plurality of additional apparatuses, and the outputting of the normal signal comprises outputting the normal signal only to the additional apparatus corresponding to the input signal.

The method may further comprise supplying power to the additional apparatus corresponding to the input signal.

The power supplied from the power supplying part to the additional apparatus corresponding to the input signal may be broken by the power-saving signal, and the power is supplied to the additional apparatus by the normal signal.

The foregoing and/or other aspects and utilities of the present general inventive concept may also be achieved by providing a method of controlling an additional apparatus to be installed at an image forming apparatus having an interface, a power supplying part to output power through the interface part of the image forming apparatus, and a control part to output power-saving mode information through the interface part of the image forming apparatus when the image forming apparatus is operated in a power-saving mode, the method comprising applying power from the image forming apparatus to the additional apparatus, receiving a power-saving signal including the power-saving mode information from the image forming apparatus, and breaking the power according to the power-saving signal.

The method may further comprise receiving a normal signal including normal mode information of operating in a normal mode from the image forming apparatus, and supplying the power to the additional apparatus according to the normal signal.

The foregoing and/or other aspects and utilities of the present general inventive concept may also be achieved by providing an image forming system, including an image forming apparatus having an image forming part to operate in one of a power saving mode and a normal mode, and an additional apparatus connectable and/or attachable to the image forming apparatus to operate according to the one of the power saving mode and the normal mode.

The foregoing and/or other aspects and utilities of the present general inventive concept may also be achieved by providing an image forming apparatus, including an image forming part to form an image, and a control unit to control the image forming part in one of a power saving mode and a normal mode, and to output the one of the power saving mode and the normal mode to an external additional apparatus detachably attachable to the image forming part.

The foregoing and/or other aspects and utilities of the present general inventive concept may also be achieved by providing an additional apparatus connectable and/or attachable to an image forming apparatus having an image forming part, the additional apparatus including a power switching part to receive a power from the image forming apparatus, and a control part to control the power switching part according to the power and one of a power saving mode and a normal mode received from the image forming apparatus.

The foregoing and/or other aspects and utilities of the present general inventive concept may also be achieved by providing an image forming system, including an image forming apparatus having an image forming part to operate in one of a power saving mode and a normal mode and to output a second power saving mode and a second normal mode, and an additional apparatus connectable and/or attachable to the image forming apparatus to operate according to one of the second power saving mode and the second normal mode.

The foregoing and/or other aspects and utilities of the present general inventive concept may also be achieved by providing an image forming apparatus, including an image forming part to form an image, and a control unit to control the image forming part to operate in one of a power saving mode and a normal mode and to output the one of a second power saving mode and a second normal mode to an external additional apparatus detachably attachable to the image forming part.

The foregoing and/or other aspects and utilities of the present general inventive concept may also be achieved by providing a method of controlling an image forming system having an additional apparatus to be installed at an image forming apparatus, the method including operating an image forming part in one of a power saving mode and a normal mode, and operating an additional apparatus connectable and/or attachable to the image forming apparatus according to the one of the power saving mode and the normal mode.

The foregoing and/or other aspects and utilities of the present general inventive concept may also be achieved by providing a method of controlling an image forming system having an additional apparatus to be installed at an image forming apparatus, the method including controlling an image forming apparatus having an image forming part to operate in one of a power saving mode and a normal mode and to output a second power saving mode and a second normal mode, and operating an additional apparatus connectable and/or attachable to the image forming apparatus according to one of the second power saving mode and the second normal mode.

The foregoing and/or other aspects and utilities of the present general inventive concept may also be achieved by providing a computer readable recording medium containing computer readable codes to perform the above-described method of controlling an additional apparatus detachably attached to an image forming apparatus.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view illustrating an image forming apparatus and an additional apparatus connectable and/or attachable to the image forming apparatus according to an embodiment of the present general inventive concept;

FIG. 2 is a control block diagram illustrating the image forming apparatus and the additional apparatus of FIG. 1 according to another embodiment of the present general inventive concept; and

FIG. 3 is a control flowchart illustrating a method of controlling an image forming apparatus and an additional apparatus connectable and/or attachable to the image forming apparatus according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

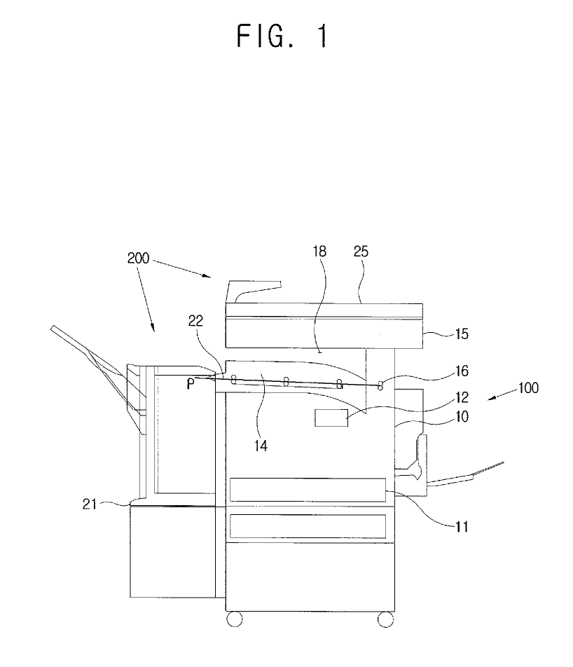

FIG. 1 is a cross-sectional view illustrating an image forming apparatus 100 and an additional apparatus 200 connectable and/or attachable to the image forming apparatus 100 according to an embodiment of the present general inventive concept. Referring to FIG. 1, the image forming apparatus 100 comprises an internal tray type main body 10 and a reading part 15. The main body 10 includes an image forming part 12, a paper feeding cassette 11, a discharging roller 16, and a discharged paper storing part 18. The reading part 15 can read a document image and transfer the document image information to the image forming part 12.

If printing paper is supplied from the paper feeding cassette 11 to the image forming part 12, the image forming part 12 forms an image on the printing paper by performing a predetermined image forming process. Then, the printing paper on which the image is formed is discharged by the discharging roller 16.

According to the present general inventive concept, the image forming apparatus 100 may be provided with a finisher 21 and a duplex apparatus 25 as the additional apparatus 200.

In a case that the finisher 21 is not provided in the image forming apparatus 100, a paper returning unit 14 is not provided. In this case, the discharging roller 16 discharges the printing papers to the discharged paper storing part 18 disposed between the main body 10 and the reading part 15 so that the printing papers are stored therein. In a case that the finisher 21 is provided in the image forming apparatus 100, the paper returning unit 14 is provided in the discharged paper storing part 18 so as to receive the printing paper from the discharging roller 16 of the main body 10 and then return the printing paper to a paper receiving part 22 of the finisher 21. As described above, the finisher 21 can support a paper discharging function.

Further, the duplex apparatus 25 is disposed at an upper end of the reading part 15 to support the double-sided copying function and the like.

In the present embodiment, the additional apparatus 200 comprises the duplex apparatus 25 and the finisher 21. However, the additional apparatus 200 may be a large capacity cassette, a facsimile, a copier, a printer, etc. Any apparatuses that can be mounted to the main body may be the additional apparatus 200.

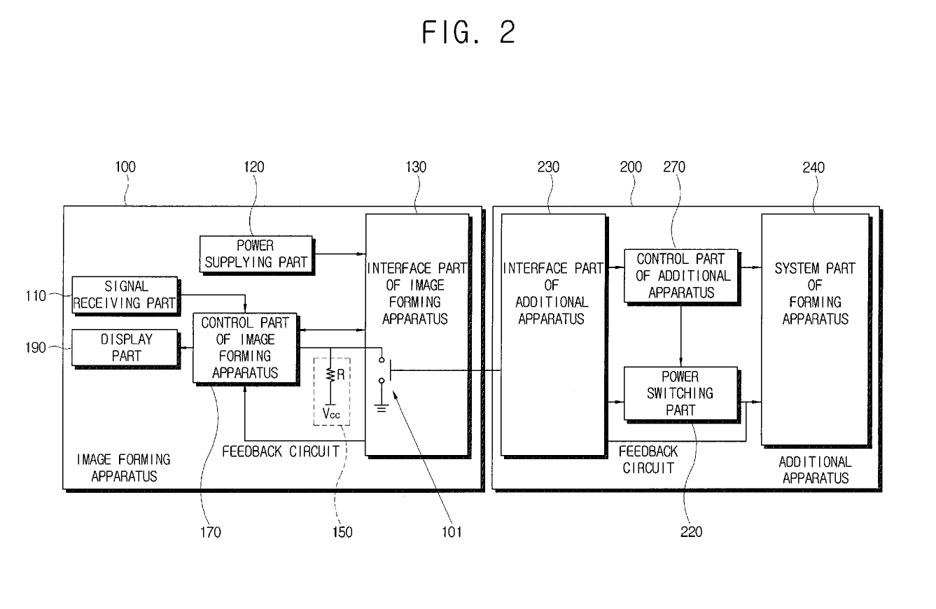

FIG. 2 is a control block diagram illustrating the image forming apparatus 100 and the additional apparatus 200 of FIG. 2 according to an embodiment of the present general inventive concept.

Referring to FIGS. 1 and 2, the image forming apparatus 100 comprises a signal receiving part 110 to receive a predetermined input signal, an interface part 130 to communicate with the additional apparatus 200, an installation detecting part 150 to detect whether or not the additional apparatus 200 is installed at the interface part 130, and a control part 170 to control components thereof including the above-described parts. Further, the image forming apparatus 100 may further comprise a power supplying part 120 to supply power and a display part 190 to display given information.

The additional apparatus 200 of the present embodiment comprises an interface part 230 to communicate with the image forming apparatus 100 through the interface part 130, a power switching part 220 to switch the power supplied from the power supplying part 120, a system part 240, and a control part 270 to control electrical and mechanical elements of the additional apparatus 200 including the above-described parts.

The signal receiving part 110 of the image forming apparatus 100 according to the present embodiment may comprise a user selection part (not shown) such as a plurality of input keys, buttons, touch pads, scroll keys, a mouse, etc., for a user to input or select a desired function. In addition, the signal receiving part 110 may comprises a terminal (not shown) to input various signals through a network.

The power supplying part 120 supplies the power to the additional apparatus 200 through the interface part 130 of the image forming apparatus 100 (to be described below). Although it is not illustrated, the power supplying part 120 may supply the power to each part of the image forming apparatus 100 as well as the additional apparatus 200, i.e., the display part 190, the control part 170 of the image forming apparatus 100, the installation detecting part 150, the signal receiving part 110, the interface part 130 of the image forming apparatus 100, etc.

The interface part 130 of the image forming apparatus 100 communicates with the additional apparatus 200 through the interface part 230. The additional apparatus 200 is installed at the interface part 130 of the image forming apparatus 100. The power supplying part 120 supplies the power to the additional apparatus 200 through the interface 130 of the image forming apparatus 100. The control part 170 of the image forming apparatus 100 outputs a level control signal to the control part 270 of the additional apparatus 200 through the interface part 130 of the image forming apparatus 100 and the interface part 230 of the additional apparatus 200 so as to control a power level of the additional apparatus 200. The interface part 130 of the image forming apparatus 100 may communicate with the interface part 230 of the additional apparatus 200 through a universal asynchronous receiver transmitter (UART) or universal serial bus (USB) manner. However, the communication manner is not limited thereto.

The installation detecting part 150 detects whether or not the additional apparatus 200 is installed at the interface part 130 of the image forming apparatus 100. Here, the installation detecting part 150 comprises at least one of a pull-up resistor R and a pull-down resistor (not illustrated) so that the additional apparatus 200 can output at least one of a pull-up signal and a pull-down signal to the control part 170 of the image forming apparatus 100 according to whether or not the additional apparatus 200 is installed at the interface part 130 of the image forming apparatus 100.

For example, in a case that the additional apparatus 200 is not installed at a predetermined pin 101 of the interface part 130 of the image forming apparatus 100, the predetermined pin of the interface part 130 of the image forming apparatus 100 may be grounded. Thus, since the predetermined pin 101 is OFF, i.e., is shorted with one end of the pull-up resistor R of the installation detecting part 150, the installation detecting part 150 can output a high signal to the control part 170 of the image forming apparatus 100.

In a case that the additional apparatus 200 is installed at the predetermined pin 101 of the interface part 130 of the image forming apparatus 100, the pin 101 is ON, i.e., is connected with one end of the pull-up resistor R. Since the pin of the interface part 130 of the image forming apparatus 100 is grounded, one end of the pull-up resistor R is grounded and the installation detecting part 150 can output a low signal to the control part 170 of the image forming apparatus 100. When the pull-down resistor is used in the installation detecting part 150, a high signal is output to the control part 170 when the additional apparatus 200 is installed, and a low signal is output to the control part 170 when the additional apparatus 200 is not installed.

The control part 170 of the image forming apparatus 100 can be operated in a normal mode or a power-saving mode. In the power-saving mode, the power is not supplied to each part of the image forming apparatus 100. That is, the power is not supplied to the additional apparatus 200. However, in the power-saving mode, the power may be supplied only to the control part 170 of the image forming apparatus 100 and the signal receiving part 110 so as to detect whether a signal to release the power-saving mode is received through the signal receiving part 110. The normal mode includes other modes than the power-saving mode. In the normal mode, the power is supplied to each part of the image forming apparatus 100.

In a case that the control part 170 of the image forming apparatus 100 is operated in the power-saving mode, a power-saving signal including power-saving mode information of operating in the power-saving mode is output through the interface part 130 of the image forming apparatus 100 to the additional apparatus 200 attached at the interface part 130 of the image forming apparatus 100. Then, the additional apparatus 200 breaks the power supplied from the power supplying part 120. The term of “break the power” indicates ‘stop outputting the power, generating the power, or distributing the power.

If a predetermined input signal is received through the signal receiving part 110 while in the power-saving mode, the power-saving mode is released, and the control part 170 of the image forming apparatus 100 is then operated in the normal mode. The control part 170 of the image forming apparatus 100 analyzes the input signal and determines whether it is necessary to operate the additional apparatus 200 in the normal mode. Further, the control part 170 of the image forming apparatus 100 outputs a normal signal including normal mode information of operating in the normal mode to the additional apparatus 200 which is to be operated in the normal mode according to a determined result of the control part 170 of the image forming apparatus 100.

For example, in a case that the image forming apparatus 100 of the present embodiment is an multi-function peripheral (MFP), and the finisher 21 and the duplex apparatus 25 are installed on the image forming apparatus 100 as illustrated in FIG. 1, an input signal to select a printing function in the power-saving mode may be received through the signal receiving part 110. If a function of only the finisher 21 is selected but a function of the duplex apparatus 25 is not selected by the input signal, the control part 170 of the image forming apparatus 100 can output the normal signal including the normal mode information of operating in the normal mode only to the finisher 21. Then, the finisher 21 is operated in the normal mode, and the duplex apparatus 25 is still operated in the power-saving mode.

Further, the image forming apparatus 100 of the present embodiment may further comprise a feedback circuit to feed back a power status of the additional apparatus 200 in order to determine whether the power is supplied to the additional apparatus 200. Therefore, the control part 170 of the image forming apparatus 100 can determine the power status of the additional apparatus 200 by the feedback circuit, and control the display part 190 to display the determined result. The feedback circuit may include a communication between the interface parts 130 and 230 through a signal line (not shown) to transmit the power status of the additional apparatus and the mode signals.

In a case that the additional apparatus 200 is operated in the power-saving mode, the additional apparatus 200 breaks the power supplied from the power supplying part 120. Further, in a case that the additional apparatus 200 is operated in the normal mode, the additional apparatus 200 receives the power from the power supplying part 120.

In a case that it is determined that the additional apparatus 200 is operated in the power-saving mode and the feedback circuit determines that the power is supplied to the additional apparatus 200, the control part 170 of the image forming apparatus 100 can determine that the additional apparatus 200 is operated erroneously. Further, in a case that the additional apparatus 200 is operated in the normal mode and the feedback circuit determines that the power is not supplied to the additional apparatus 200, the control part 170 of the image forming apparatus 100 can determine that the additional apparatus 200 is operated erroneously. Further, the control part 170 of the image forming apparatus 100 can control the display part 190 to notify a user whether the additional apparatus 200 is operated erroneously.

Here, the display part 190 may comprise various display units such as a liquid crystal display (LED) unit, a light emitting diode (LED) display unit, etc., which can display the power status of the additional apparatus 200.

The additional apparatus 200 of the present embodiment can communicate with the image forming apparatus 100 through the interface part 230. The interface part 230 of the additional apparatus 200 communicates in the same manner as the interface part 130 of the image forming apparatus 100. The interface part 230 of the additional apparatus 200 is connected with the interface part 130 of the image forming apparatus 100, to thereby receive the power from the image forming apparatus 100 and various control signals including the level control signal output from the control part 170 of the image forming apparatus 100.

The power switching part 220 switches the power from the power supplying part 120 of the image forming apparatus 100 through the interface part 230 of the additional apparatus 200. The power switching part 220 switches the power by a control signal of the control part 270 of the additional apparatus 200.

The system part 240 of the additional apparatus 200 is operated by the power supplied from the power supplying part 120 of the image forming apparatus 100 so as to perform various functions of the additional apparatus 200. The system part 240 of the additional apparatus 200 includes all parts of the additional apparatus 200 except the interface part 230 of the additional apparatus 200, the power switching part 220, and the control part 270.

If the image forming apparatus 100 is operated in the power-saving mode and thus the power-saving signal having the power-saving mode information of operating in the power-saving mode is transmitted to the control part 270, the control part 270 of the additional apparatus 200 controls the power switching part 220 to break the power supplied from the power supplying part 120.

If the image forming apparatus 100 is operated in the normal mode and thus the normal signal including the normal mode information of operating in the normal mode is transmitted to the control part 270, the control part 270 of the additional apparatus 200 controls the power switching part 220 to supply the power from the power supplying part 120.

Further, the additional apparatus 200 may supply the power only to the control part 270 which can determine whether the normal signal is received in the power-saving mode. At this time, the control part 270 of the additional apparatus 200 may receive the power from the power supplying part 120 of the image forming apparatus or from another power supplying source such as a separate battery and the like.

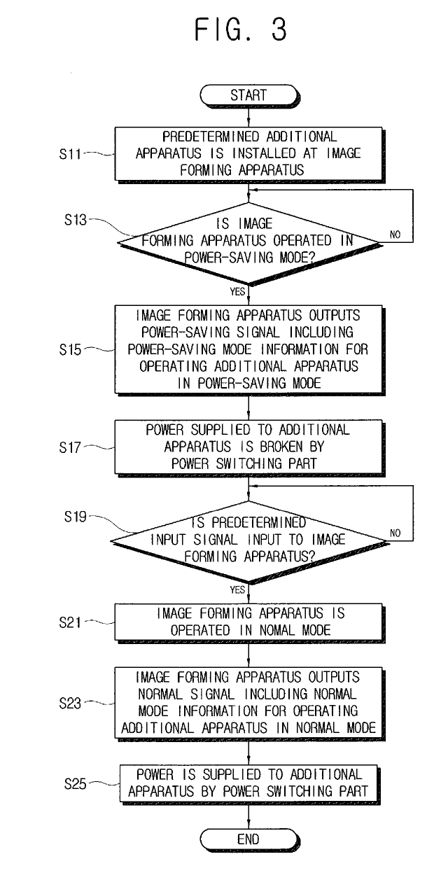

FIG. 3 is a control flowchart illustrating a method of controlling an image forming apparatus and an additional apparatus connectable and/or attachable to the image forming apparatus according to another embodiment of the present general inventive concept. Referring to FIGS. 1 through 3, the additional apparatus 200 is installed to the image forming apparatus 100 of the present general inventive concept at operation S11. If it is determined that the image forming apparatus 100 to which the desired additional apparatus 200 is installed is operating in the power-saving mode at operation S13, the power-saving signal including the power-saving mode information of operating in the power-saving mode is output to the additional apparatus 200 at operation S15. If the power-saving signal is transmitted to the additional apparatus 200, the additional apparatus 200 turns off the power switching part 220 at operation S17. Then, the power supplied from the power supplying part 120 of the image forming apparatus 100 to the additional apparatus 200 is broken.

If it is determined that the predetermined input signal is transmitted to the image forming apparatus 100 through the signal receiving part 110 at operation S19, the image forming apparatus 100 is operated in the normal mode at operation S21. At this time, the input signal may be selected by the user selection part or received through the network, and may include a signal to perform the desired function.

If the image forming apparatus 100 receives the input signal, the image forming apparatus 100 analyzes the input signal and outputs the normal signal including the normal mode information to the additional apparatuses 200 which are needed to perform the function corresponding to the input signal at operation S23. Then, the control part 270 of the additional apparatus 200 turns on the power switching part 220 at operation S25, and thus the power is supplied to each part of the additional apparatus 200.

In a case that one or more additional apparatuses are installed to the image forming apparatus 100, the image forming apparatus 100 outputs the normal signal to at least one of the additional apparatuses 200 which are needed to perform a function corresponding to the input signal, only a selected one of the additional apparatuses which receives the normal signal among the one or more additional apparatuses 200 is operated in the normal mode, the other additional apparatus 200 remains in the power-saving mode.

Further, if the additional apparatus 200 is operated in the power-saving mode while the image forming apparatus 100 is operated in the normal mode, the control part 170 of the image forming apparatus 100 outputs the normal signal again to the one or more additional apparatuses 200 required to perform the function corresponding to the input signal.

As described above, the image forming apparatus 100 of the present general inventive concept drives only a required one of one or more additional apparatuses to operate in the normal mode, to thereby reduce the power consumed by the one or more additional apparatus 200.

As described above, since the present general inventive concept provides a power switch to break power supplied from a power supplying part is provided in the additional apparatus, it is possible to reduce a production cost of the image forming apparatus.

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

As described above, the present general inventive concept provides an image forming apparatus, an additional apparatus and a control method thereof, in which power can be supplied to additional apparatuses which are necessary to perform a function.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus having a normal mode and a power-saving mode, comprising:
a signal receiving part;
an interface part to which a predetermined additional apparatus is installed;
an installation detecting part to detect whether the additional apparatus is installed at the interface part of the image forming apparatus; and
a control part to output a power-saving signal including power-saving mode information of operating in the power-saving mode to the additional apparatus installed at the interface part of the image forming apparatus through the interface part of the image forming apparatus when the image forming apparatus is operated in the power-saving mode, and to output a normal signal including normal mode information of operating the additional apparatus in the normal mode through the interface part of the image forming apparatus when a predetermined input signal is input through the signal receiving part.

2. The image forming apparatus according to claim 1, wherein the control part of the image forming apparatus is operated in the normal mode after the input signal is received.

3. The image forming apparatus according to claim 2, wherein:
the additional apparatus comprises a plurality of additional apparatuses installed at the interface part of the image forming apparatus; and
the control part outputs the normal signal only to the additional apparatuses corresponding to the input signal when the input signal is received.

4. The image forming apparatus according to claim, wherein the installation detecting part comprises at least one of a pull-up resistor and a pull-down resistor, and outputs at least one of a pull-up signal and a pull-down signal as a detecting signal generated by the at least one pull-up resistor and the pull-down resistor to the control part.

5. The image forming apparatus according to claim 4, further comprising:
a power supplying part to supply power to the additional apparatus corresponding to the input signal.

6. The image forming apparatus according to claim 5, wherein:
the power-saving signal breaks the power from the power supplying part to the additional apparatus; and
the normal signal supplies the power to the additional apparatus.

7. The image forming apparatus according to claim 6, further comprising:
a feedback circuit to feed back a power status of the additional apparatus,
wherein the control part of the image forming apparatus determines the power status of the additional apparatus by the feedback circuit.

8. The image forming apparatus according to claim 7, further comprising:
a display part to display an image,
wherein the control part determines whether the power is supplied to the additional apparatus and controls the display part to display the power status of the additional apparatus according to a determination of whether the additional apparatus is in the normal mode or the power saving mode.

9. An additional apparatus usable with an image forming apparatus having an interface part, a power supplying part to output power through an interface part of the image forming apparatus, and a control part to output a power-saving signal including power-saving mode information through the interface part when the image forming apparatus is operated in the power-saving mode, the additional apparatus comprising:
a power switching part to switch power supplied from an image forming apparatus; and
a control part to control the power switching part to break the power when the power-saving signal is received from the image forming apparatus.

10. The apparatus according to claim 9, wherein the control part controls the power switching part to supply the power when a normal signal including normal mode information of operating in a normal mode is received from the image forming apparatus.

11. A method of controlling an image forming apparatus which is operated in a normal mode or a power-saving mode, the method comprising:
installing a predetermined additional apparatus on the image forming apparatus;
detecting whether the additional apparatus is installed;
outputting a power-saving signal including power-saving mode information of operating in a power-saving mode to the additional apparatus when the image forming apparatus is operated in the power-saving mode;
receiving a predetermined input signal; and
outputting a normal signal including normal mode information of operating the additional apparatus in a normal mode when the input signal is received.

12. The method according to claim 11, further comprising:
operating the image forming apparatus in the normal mode when the predetermined input signal is received.

13. The method according to claim 12, wherein:
the installing of the predetermined additional apparatus comprises installing a plurality of additional apparatuses on the image forming apparatus; and
the outputting of the normal signal comprises outputting the normal signal only to the additional apparatus corresponding to the input signal.

14. The method according to claim 13, further comprising:
supplying power to the additional apparatus corresponding to the input signal.

15. The method according to claim 14, wherein:
the power supplied from the power supplying part to the additional apparatus corresponding to the input signal is broken by the power-saving signal; and
the power is supplied to the additional apparatus by the normal signal.

16. A method of controlling an additional apparatus to be installed at an image forming apparatus having an interface, a power supplying part to output power through the interface part of the image forming apparatus, and a control part to output power-saving mode information through the interface part of the image forming apparatus when the image forming apparatus is operated in a power-saving mode, the method comprising:
applying power from the image forming apparatus;
receiving a power-saving signal including the power-saving mode information from the image forming apparatus; and
breaking the power according to the power-saving signal.

17. The method according to claim 16, further comprising:
receiving a normal signal including normal mode information of operating in a normal mode from the image forming apparatus; and
supplying the power to the additional apparatus according to the normal signal.

18. An image forming system, comprising:
an image forming apparatus having an image forming part to operate in one of a power saving mode and a normal mode; and
an additional apparatus connectable and/or attachable to the image forming apparatus to operate according to the one of the power saving mode and the normal mode.

19. The image forming system according to claim 18, wherein the image forming apparatus comprises a power supply to supply a power to the additional apparatus, and the additional apparatus operates according to the power and the one of the power saving mode and the normal mode

20. An image forming apparatus, comprising:
an image forming part to form an image; and
a control unit to control the image forming part in one of a power saving mode and a normal mode, and to output the one of the power saving mode and the normal mode to an external additional apparatus detachably attachable to the image forming part.

21. An additional apparatus connectable and/or attachable to an image forming apparatus having an image forming part, the additional apparatus comprising:
a power switching part to receive a power from the image forming apparatus; and
a control part to control the power switching part according to the power and one of a power saving mode and a normal mode received from the image forming apparatus.

22. An image forming system, comprising:
an image forming apparatus having an image forming part to operate in one of a power saving mode and a normal mode and to output a second power saving mode and a second normal mode; and
an additional apparatus connectable and/or attachable to the image forming apparatus to operate according to one of the second power saving mode and the second normal mode.

23. The image forming system according to claim 22, wherein the image forming apparatus comprises a power supply to supply a power to the additional apparatus, and the additional apparatus operates according to the power and the one of the second power saving mode and the second normal mode.

24. The image forming system according to claim 22, further comprising:
a second additional apparatus connectable and/or attachable to the image forming apparatus;
wherein the image forming apparatus outputs a third power saving mode and a third second normal mode, and the second additional apparatus operates according to the one of the third power saving mode and the third normal mode.

25. An image forming apparatus, comprising:
an image forming part to form an image; and
a control unit to control the image forming part to operate in one of a power saving mode and a normal mode and to output the one of a second power saving mode and a second normal mode to an external additional apparatus detachably attachable to the image forming part.

26. A method of controlling an image forming system having an additional apparatus to be installed at an image forming apparatus, the method comprising:
operating an image forming part in one of a power saving mode and a normal mode; and
operating an additional apparatus connectable and/or attachable to the image forming apparatus according to the one of the power saving mode and the normal mode.

27. A method of controlling an image forming system having an additional apparatus to be installed at an image forming apparatus, the method comprising:
controlling an image forming apparatus having an image forming part to operate in one of a power saving mode and a normal mode and to output a second power saving mode and a second normal mode; and
operating an additional apparatus connectable and/or attachable to the image forming apparatus according to one of the second power saving mode and the second normal mode.

28. A computer readable recording medium containing computer readable codes to perform a method of controlling an additional apparatus detachably attached to an image forming apparatus, the method comprising:
operating an image forming part in one of a power saving mode and a normal mode; and
operating an additional apparatus connectable and/or attachable to the image forming apparatus according to the one of the power saving mode and the normal mode

29. A computer readable recording medium containing computer readable codes to perform a method of controlling an additional apparatus detachably attached to an image forming apparatus, the method comprising:
controlling an image forming apparatus having an image forming part to operate in one of a power saving mode and a normal mode and to output a second power saving mode and a second normal mode; and
operating an additional apparatus connectable and/or attachable to the image forming apparatus according to one of the second power saving mode and the second normal mode.
